(19) United States
(12) Patent Application Publication
(10) Pub. No.: US 2014/0150018 A1
(43) Pub. Date: May 29, 2014

(54) APPARATUS FOR RECEIVING AUGMENTED BROADCAST, METHOD OF RECEIVING AUGMENTED BROADCAST CONTENT USING THE SAME, AND SYSTEM FOR PROVIDING AUGMENTED BROADCAST CONTENT

(71) Applicant: Electronics and Telecommunications Research Institute, Daejeon (KR)

(72) Inventors: Jeoung-Lak HA, Daejeon-si (KR); Soon-Choul KIM, Daejeon-si (KR); Jung-Hak KIM, Daejeon-si (KR); Bum-Suk CHOI, Daejeon-si (KR); Young-Ho JEONG, Daejeon-si (KR); Jin-Woo HONG, Daejeon-si (KR)

(21) Appl. No.: 13/905,983

(22) Filed: May 30, 2013

(30) Foreign Application Priority Data
Nov. 27, 2012 (KR) 10-2012-0135475

(51) Int. Cl. H04N 21/237

(52) U.S. Cl. CPC H04N 21/237
USPC 725/34; 725/32

(57) ABSTRACT

An apparatus for receiving augmented broadcast, a method of receiving augmented broadcast content using the same, and a system for providing augmented broadcast content are provided. The method of receiving augmented broadcast content may include receiving a broadcast program and metadata for augmented broadcast implementation for the broadcast program that are transmitted over a broadcasting network, requesting an augmented broadcast content providing server providing augmented broadcast content associated with the broadcast program to provide the augmented broadcast content associated with the broadcast program with reference to the received metadata, and receiving the augmented broadcast content provided by the augmented broadcast content providing server according to the request.

### CROSS-REFERENCE TO RELATED APPLICATION

This application claims the benefit under 35 U.S.C. §119(a) of a Korean Patent Application No. 10-2012-0135475, filed on Nov. 27, 2012, the entire disclosure of which is incorporated herein by reference for all purposes.

### BACKGROUND

1. Field

The following description relates to content providing technology, and more particularly, to an apparatus for receiving augmented broadcast, a method of receiving augmented broadcast content using the same, and a system for providing augmented broadcast content.

2. Description of the Related Art

Augmented reality (AR) is technology for displaying a virtual object overlapping real world that a user looks at with eyes, and is called mixed reality (MR) since virtual world having additional information and the real world overlap in real time to be displayed as one image.

Meanwhile, in a recent smart television (TV) environment, it is possible to receive and watch augmented broadcast content indicated by metadata provided together with a broadcast program over a broadcasting network, based on the metadata. With the development of a content industry, there are various augmented broadcast content indicated by metadata, and viewers have a chance to select and watch desired content from among the various content. However, a process of selecting content based on the metadata obstructs watching of a broadcast program. For example, it is difficult for a viewer to currently sufficiently devote to a broadcast program or a video on demand in real time when selecting the content based on the metadata after receiving the metadata.

### SUMMARY

Provided are an apparatus for receiving augmented broadcast, a method of receiving augmented broadcast content using the same, and a system for providing augmented broadcast content that are capable of providing, through the same metadata, augmented broadcast content provided by a plurality of content providers (CPs) and enabling a user to automatically download and watch augmented broadcast content selected in advance without being disturbed for real-time watching.

In one general aspect, a method of receiving augmented broadcast content includes receiving a broadcast program and metadata for augmented broadcast implementation for the broadcast program that are transmitted over a broadcasting network; requesting an augmented broadcast content providing server providing augmented broadcast content associated with the broadcast program to provide the augmented broadcast content associated with the broadcast program with reference to the received metadata; and receiving the augmented broadcast content provided by the augmented broadcast content providing server according to the request.

In another general aspect, an apparatus for receiving augmented broadcast includes a broadcast/metadata reception unit configured to receive a broadcast program and metadata for augmented broadcast that are transmitted over a broadcasting network; a content request unit configured to request an augmented broadcast content providing server providing augmented broadcast content associated with the broadcast program to provide the augmented broadcast content associated with the broadcast program with reference to the received metadata; and a content reception unit configured to receive the augmented broadcast content provided by the augmented broadcast content providing server according to the request.

In still another general aspect, a system for providing augmented broadcast content includes at least one augmented broadcast content providing server configured to store augmented broadcast content associated with a broadcast program; and an augmented broadcast receiving apparatus configured to receive the broadcast program and metadata for augmented broadcast that are transmitted over a broadcasting network, request the augmented broadcast content providing server to provide the augmented broadcast content associated with the broadcast program with reference to the received metadata, and receive the augmented broadcast content associated with the broadcast program.

### BRIEF DESCRIPTION OF THE DRAWINGS

FIG. 1 is a diagram illustrating a configuration of an augmented broadcast content providing system according to an embodiment of the present invention;

FIG. 2 is a diagram illustrating a detailed configuration of an augmented broadcast receiving apparatus 150 of FIG. 1;

FIG. 3 is a diagram illustrating an example of a broadcast stream for augmented broadcast according to an embodiment of the present invention;

FIG. 4 is a diagram illustrating an example of metadata according to an embodiment of the present invention;

FIG. 5 is a diagram illustrating an example of augmented object information 410 of FIG. 4.

FIG. 6 is a flowchart of a method of providing an augmented broadcast content according to an embodiment of the present invention;

FIG. 7 is a diagram illustrating a configuration of an augmented broadcast content providing system according to another embodiment of the present invention;

FIG. 8 is a diagram illustrating an example of augmented object information included in metadata of the augmented broadcast content providing system 700 of FIG. 7;

FIG. 9 is a diagram illustrating an example of elements of the augmented object information of FIG. 8;

FIG. 10 is a diagram illustrating an example of a directory structure of a representative server 770 of FIG. 7 when the representative server 770 directly holds augmented broadcast content provided by each augmented broadcast content providing server;

FIGS. 11a to 11d are diagrams illustrating examples of a structure of an augmented broadcast content file in a directory of the representative server 770 according to an embodiment of the present invention; and

FIG. 12 is a flowchart of a method of providing an augmented broadcast content according to another embodiment of the present invention.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

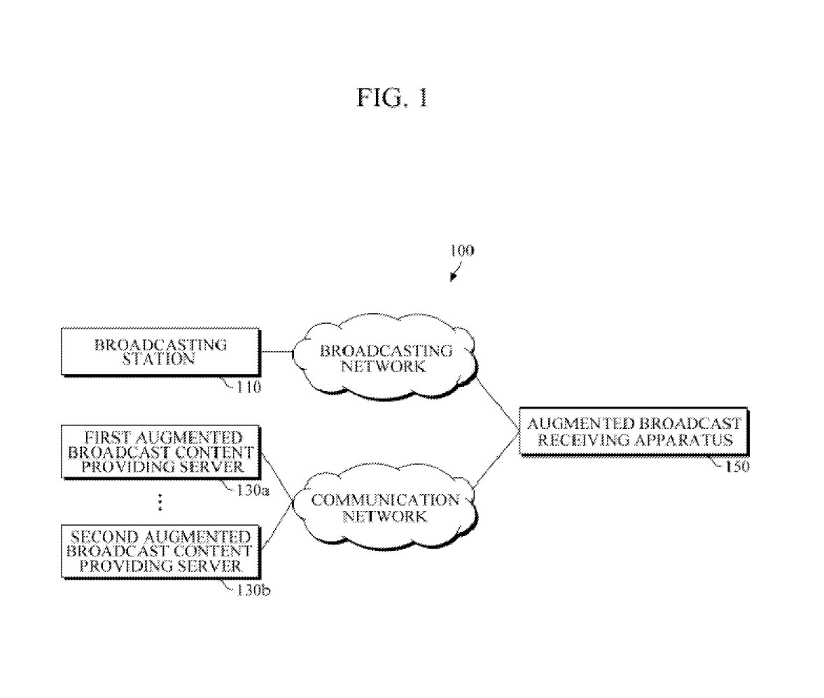

FIG. 1 is a diagram illustrating a configuration of an augmented broadcast content providing system according to an embodiment of the present invention.

Referring to FIG. 1, the augmented broadcast content providing system according to an embodiment of the present invention may include a broadcasting station 110, augmented broadcast content providing servers 130a and 130b, and an augmented broadcast receiving apparatus 150.

The broadcasting station 110 transmits a broadcast program and metadata for augmented broadcast implementation over a broadcasting network. In this case, the broadcast program includes a video on demand as well as a real-time broadcast program, and the broadcasting network includes a broadcasting network for terrestrial broadcasting, digital multimedia broadcasting (DMB), satellite broadcasting, cable broadcasting, or Internet protocol television (IPTV), or an Internet network, but is not limited thereto.

The metadata is data for augmented broadcast implementation, and includes information for augmented broadcast content associated with a broadcast program and information on how the augmented broadcast content is displayed in association with the progress of the broadcast program.

The augmented broadcast content providing servers 130a and 130b store the augmented broadcast content associated with the broadcast program and provide the augmented broadcast content to the augmented broadcast receiving apparatus 150 over a communication network.

Each of the augmented broadcast content providing servers 130a and 130b may store and provide augmented broadcast content with a different attribute, respectively. In addition, one augmented broadcast content providing server may store and provide a plurality of augmented broadcast content having a different attribute. For example, as augmented broadcast content to be provided by a second clip in a tenth broadcast of broadcast program A, the first augmented broadcast content providing server 130a may store and provide first content that is free augmented broadcast content and second content that is paid augmented broadcast content, and the second augmented broadcast content providing server 130b may store and provide third content that is paid augmented broadcast content.

Meanwhile, if the broadcasting station 110 not only transmits a broadcast program and metadata for augmented broadcast implementation but also provides augmented broadcast content for the broadcast program, the broadcasting station 110 may perform a function of an augmented broadcast content providing server.

The augmented broadcast receiving apparatus 150 may receive the broadcast program and the metadata for augmented broadcast implementation transmitted over the broadcasting network, request the augmented broadcast content providing servers 130a and 130b to provide the augmented broadcast content associated with the broadcast program with reference to the received metadata, and receive the augmented broadcast content.

In this case, the augmented broadcast receiving apparatus 150 may request the augmented broadcast content providing server selected by a user or by default when there is no selection by the user to provide the augmented broadcast content associated with the broadcast program, and receive the augmented broadcast content.

When there are a plurality of users that use the augmented broadcast receiving apparatus 150, the augmented broadcast receiving apparatus 150 may store a user ID and a password of each user, identify the user using the user ID and the password, and request the augmented broadcast content providing server selected by the identified user to provide the augmented broadcast content.

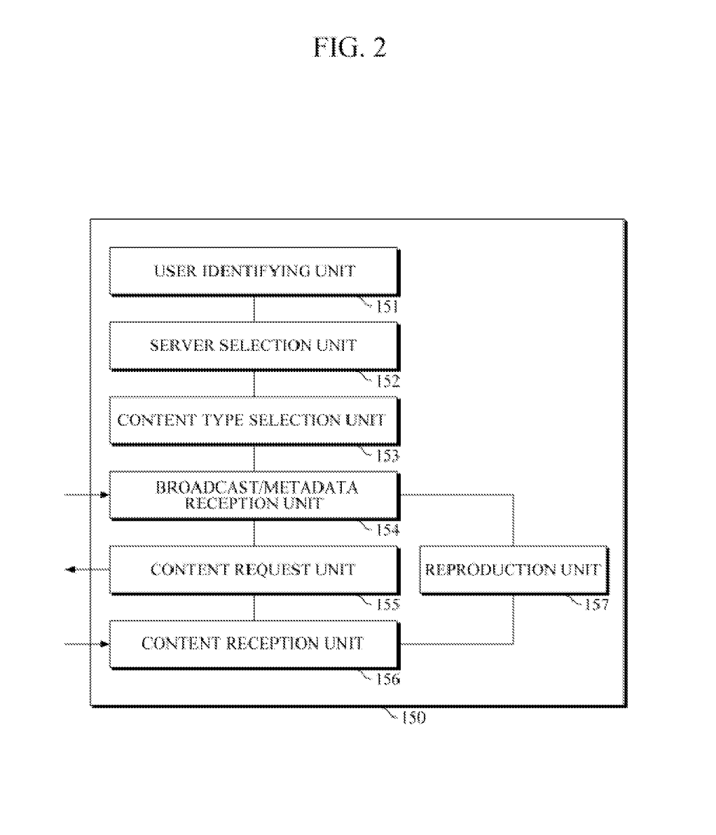

FIG. 2 is a diagram illustrating a detailed configuration of the augmented broadcast receiving apparatus 150 of FIG. 1.

Referring to FIG. 2, the augmented broadcast receiving apparatus 150 may include a user identifying unit 151, a server selection unit 152, a content type selection unit 153, a broadcast/metadata reception unit 154, a content request unit 155, a content reception unit 156, and a reproduction unit 157.

When a plurality of users use the augmented broadcast receiving apparatus 150, the user identifying unit 151 may store a user ID and a password of each user and identify a user currently using the augmented broadcast receiving apparatus 150 based on the stored user ID and password. When a plurality of users currently use the augmented broadcast receiving apparatus 150 together, the user identifying unit 151 may identify the users by establishing a priority among the users.

The server selection unit 152 may select one of the plurality of augmented broadcast content providing servers 130a and 130b providing the augmented broadcast content associated with the broadcast program transmitted from the broadcasting station 110 according to a selection of the user, and store information for the selected server. For example, when the user selects the first augmented broadcast content providing server 130a for broadcast program A and selects the second augmented broadcast content providing server 130b for broadcast program B, the server selection unit 152 may select the first augmented broadcast content providing server 130a for broadcast program A and the second augmented broadcast content providing server 130b for broadcast program B, and store related information.

In this case, when a plurality of users use the augmented broadcast receiving apparatus 150, the server selection unit 152 may store information for each server selected according to a selection of each user in association with the user ID stored in the user identifying unit 151. For example, when, for broadcast program C, user A selects the first augmented broadcast content providing server 130a and user B selects the second augmented broadcast content providing server 130b, the server selection unit 152 stores the related information with the association of user A with the first augmented broadcast content providing server 130a and user B with the second augmented broadcast content providing server 130b for broadcast program C.

When the selected augmented broadcast content providing server provides a plurality of content types having a different attribute, the content type selection unit 153 may select one of the plurality of content types according to the selection of the user and store information for the selected content type. For example, when the first augmented broadcast content providing server 130a provides a first content type and a second content type for broadcast program D and the user selects the first content type of the first augmented broadcast content providing server 130a, the content type selection unit 153 selects the first content type of the first augmented broadcast content providing server 130a for broadcast program D and stores related information.

In this case, when a plurality of users use the augmented broadcast receiving apparatus 150, the content type selection unit 153 may store information for each content type selected according to the selection of each user in association with the user identification ID stored in the user identifying unit 151.

The broadcast/metadata reception unit 154 may receive the broadcast program and the metadata for augmented broadcast implementation transmitted from the broadcasting station 110 over the broadcasting network.

The content request unit 155 can request the augmented broadcast content providing servers 130a and 130b to provide augmented broadcast content associated with the received broadcast program with reference to the metadata received by the broadcast/metadata reception unit 154.

In this case, the content request unit 155 may request the augmented broadcast content providing server selected by the server selection unit 152 to provide the augmented broadcast content associated with the broadcast program received by the broadcast/metadata reception unit 154. When the selected augmented broadcast content providing server provides a plurality of content types having a different attribute, the content request unit 155 may request the augmented broadcast content providing server to provide the augmented broadcast content corresponding to the content type selected by the content type selection unit 153.

On the other hand, when the user does not select the augmented broadcast content providing server in advance, the content request unit 155 may request a server selected by default to provide the augmented broadcast content. When the user does not select the content type in advance, the content request unit 155 may request the server to provide augmented broadcast content corresponding to a content type selected by default.

Further, when a plurality of users use the augmented broadcast receiving apparatus 150, the content request unit 155 may request an augmented broadcast content providing server selected by the user identified by the user identifying unit 151 in advance to provide the augmented broadcast content corresponding to an augmented broadcast content type selected in advance.

The content reception unit 156 may receive the augmented broadcast content provided by the augmented broadcast content providing servers 130a and 130b according to the request of the content request unit 155.

The reproduction unit 157 may reproduce the augmented broadcast content received by the content reception unit 156 with the broadcast program with reference to the metadata.

Meanwhile, the user identifying unit 151, the server selection unit 152, the content type selection unit 153 and the reproduction unit 157 may be omitted in the augmented broadcast receiving apparatus 150 or may be present as separate components outside the augmented broadcast receiving apparatus 150.

Further, the information for the content type selected by the content type selection unit 153 may be transmitted to the augmented broadcast content providing server and stored in and managed by the augmented broadcast content providing server. In this case, when the content request unit 155 requests the selected augmented broadcast content providing server to provide the augmented broadcast content, the augmented broadcast content providing server having received the request provides the augmented broadcast content based on the augmented broadcast content type information stored in advance.

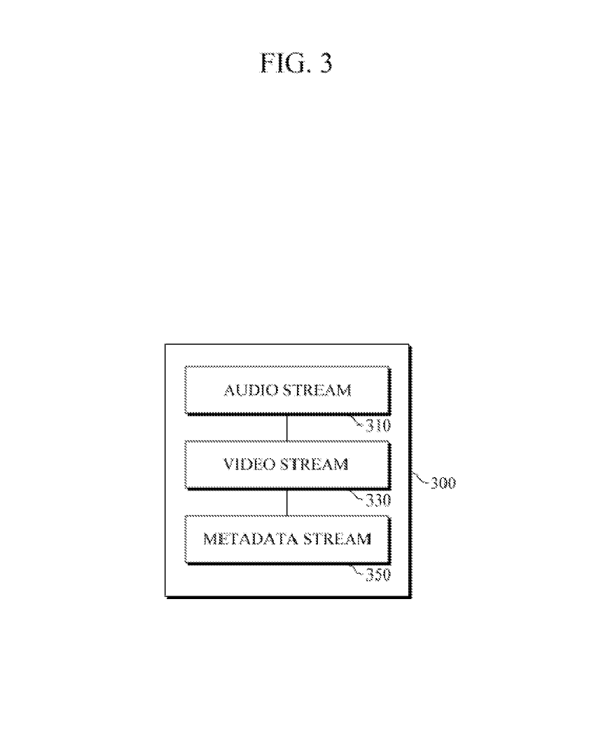

FIG. 3 is a diagram illustrating an example of a broadcast stream for augmented broadcast according to an embodiment of the present invention.

Referring to FIG. 3, a broadcast stream 300 for augmented broadcast includes an audio stream 310, a video stream 330, and a metadata stream 350. A broadcast stream for digital broadcasting typically includes the audio stream 310 and the video stream 330, and may further include various data. For augmented broadcast, the broadcast stream further includes the metadata stream 350 containing information necessary to augment the broadcast program. In other words, the broadcasting station 110 forms the broadcast program using the audio stream 310 and the video stream 330, forms the metadata for augmented broadcast implementation using the metadata stream 350, and transmits them as the broadcast stream 300.

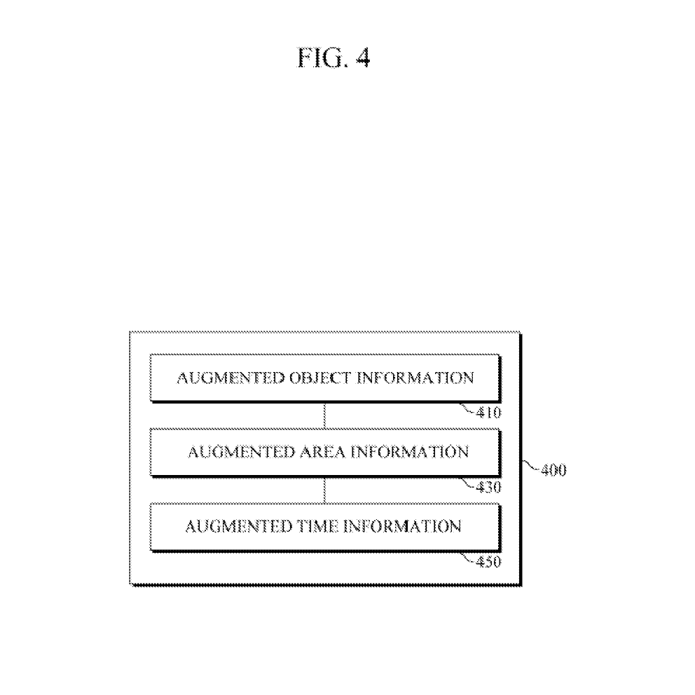

FIG. 4 is a diagram illustrating an example of the metadata according to an embodiment of the present invention.

Metadata 400 indicates information for content to be added to a broadcast program in terms of time and space.

Referring to FIG. 4, the metadata 400 can include augmented object information 410, augmented area information 430 and augmented time information 450.

The augmented object information 410 is information for augmented broadcast content to be additionally provided to the broadcast program. In this case, the augmented broadcast content may be simple content such as a circle or a quadrangle, or may be various forms of content such as a 3D content animation, a movie clip, or a map. In this case, the augmented broadcast content may appear as one file or may include several complex files that are implemented in a package form.

Meanwhile, the augmented object information 410 may be represented as uniform resource locator (URL) information for access to the augmented broadcast content.

The augmented area information 430 is information for a spatial arrangement of the augmented broadcast content on a screen and an audio in which the broadcast program is output.

The augmented time information 450 is information on a temporal arrangement of the augmented broadcast content in the broadcast program.

For example, when the metadata indicates information “Show a 3D character resembling a main character for ten seconds after starting the program in a top right corner of the screen,” the augmented object information 410 is “Show a 3D character resembling a main character,” the augmented area information 430 is “Show in a top right corner of the screen,” and the augmented time information 450 is “Show for ten seconds after starting the program.”

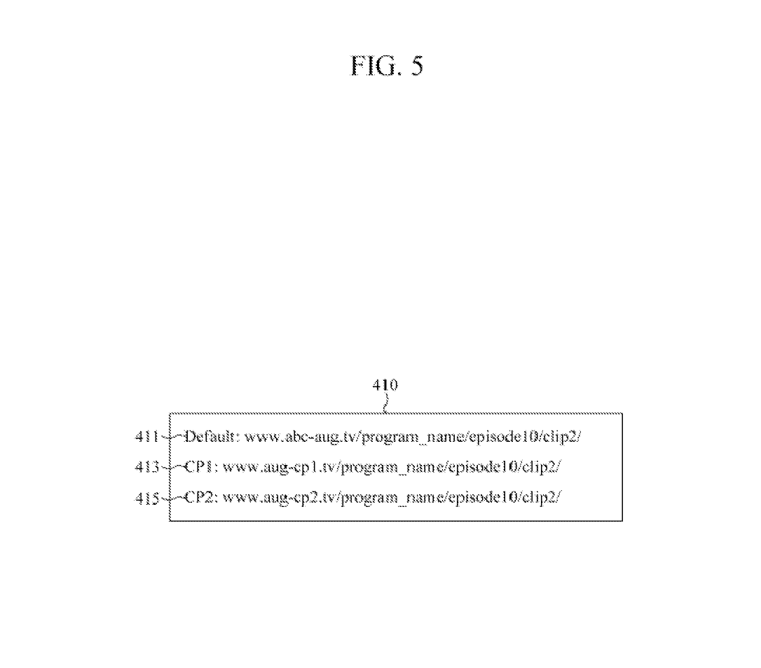

FIG. 5 is a diagram illustrating an example of the augmented object information 410 of FIG. 4.

Referring to FIG. 5, respective augmented objects of the augmented object information 410 may be represented as URL information pieces 411, 413 and 415 for access to augmented broadcast content provided by respective augmented broadcast content providing servers.

For example, when an ABC broadcasting station server, a CP1 and a CP2 are provided as servers providing augmented broadcast content to be used by a second clip in a tenth broadcast of a broadcast program “program_name,” which is provided in an ABC broadcasting station, the augmented object information 410 may include respective augmented objects represented by URLs 411, 413 and 415 for access to the respective servers.

In the above example, when a user is assumed to have selected the CP1 as an augmented broadcast content providing server, the augmented broadcast receiving apparatus 150 requests the CP1 to provide augmented broadcast content, and the CP1 having received the request provides the augmented broadcast content to the augmented broadcast receiving apparatus 150. In this case, the augmented broadcast receiving apparatus 150 accesses the CP1 using the URL information 413 for the CP1 included in the augmented object information, and downloads the augmented broadcast content.

When the CP1 selected by the user provides a plurality of content types having a different attribute and the user selects the content type in advance, the augmented broadcast receiving apparatus 150 requests the CP1 to provide augmented broadcast content corresponding to the selected content type, and the CP1 having received the request provides the augmented broadcast content corresponding to the content type selected by the user to the augmented broadcast receiving apparatus 150. In this case, the CP1 may store and manage information of the content type selected by the user, and, in response to a content request of the augmented broadcast receiving apparatus 150, the CP1 provides the augmented broadcast content to the augmented broadcast receiving apparatus 150 based on the previously stored content type information.

On the other hand, in the above example, when the user does not select the augmented broadcast content providing server, the augmented broadcast receiving apparatus 150 requests the ABC broadcasting station server selected by default to provide the augmented broadcast content, and the ABC broadcasting station server having received the request provides the augmented broadcast content to the augmented broadcast receiving apparatus 150. In this case, the augmented broadcast receiving apparatus 150 accesses the ABC broadcasting station server using the URL information 411 for the ABC broadcasting station server included in the augmented object information, and downloads the augmented broadcast content.

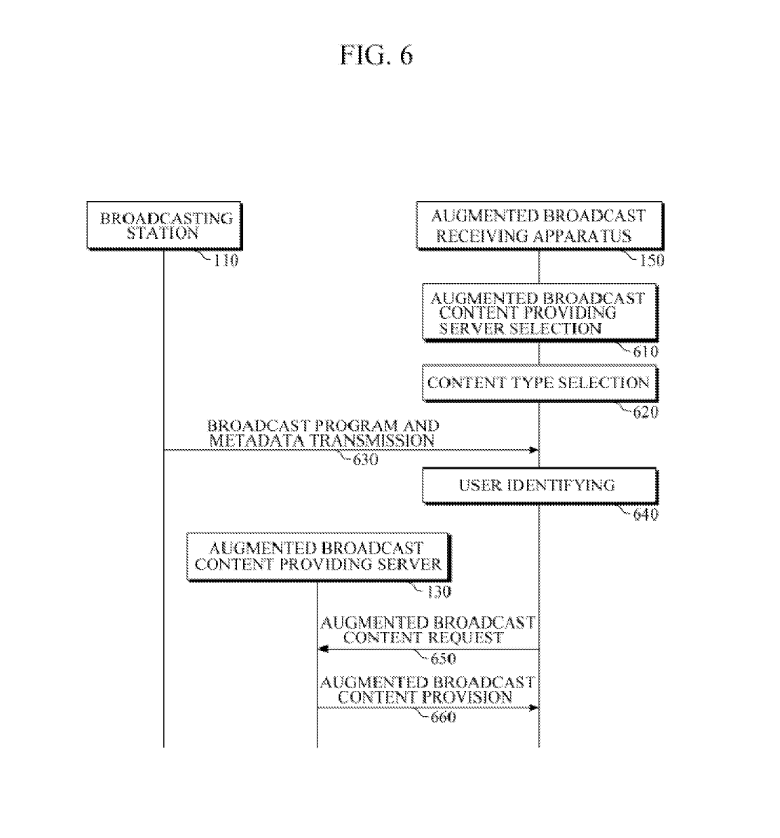

FIG. 6 is flowchart of a method of providing augmented broadcast content according to an embodiment of the present invention.

Referring to FIG. 6, in the method of providing augmented broadcast content according to an embodiment of the present invention, one of a plurality of augmented broadcast content providing servers that provide augmented broadcast content associated with a broadcast program is selected according to a selection of a user (610). Then, when the selected augmented broadcast content providing server provides a plurality of content types having a different attribute, one of the plurality of content types is selected according to a selection of the user 620).

A broadcast program and metadata for augmented broadcast implementation for the broadcast program transmitted from the broadcasting station 110 over the broadcasting network are then received (630).

When a plurality of users use the augmented broadcast receiving apparatus 150, a user currently using the augmented broadcast receiving apparatus 150 is then identified using a user ID stored in advance (640).

The augmented broadcast receiving apparatus 150 then requests the augmented broadcast content providing server 130 selected by the identified user to provide the augmented broadcast content (650), and the augmented broadcast content providing server 130 provides the augmented broadcast content to the augmented broadcast receiving apparatus 150 according to the content request (660). In this case, when the augmented broadcast content providing server 130 selected by the identified user provides a plurality of content types having a different attribute and the identified user selects one of the plurality of content types, the augmented broadcast content providing server 130 provides the augmented broadcast content corresponding to the selected content type.

In this case, when the user does not select one of the plurality of augmented broadcast content providing servers in operation 610, the augmented broadcast receiving apparatus 150 requests an augmented broadcast content providing server selected by default to provide the augmented broadcast content, and the augmented broadcast content providing server selected by default provides the augmented broadcast content according to the content request.

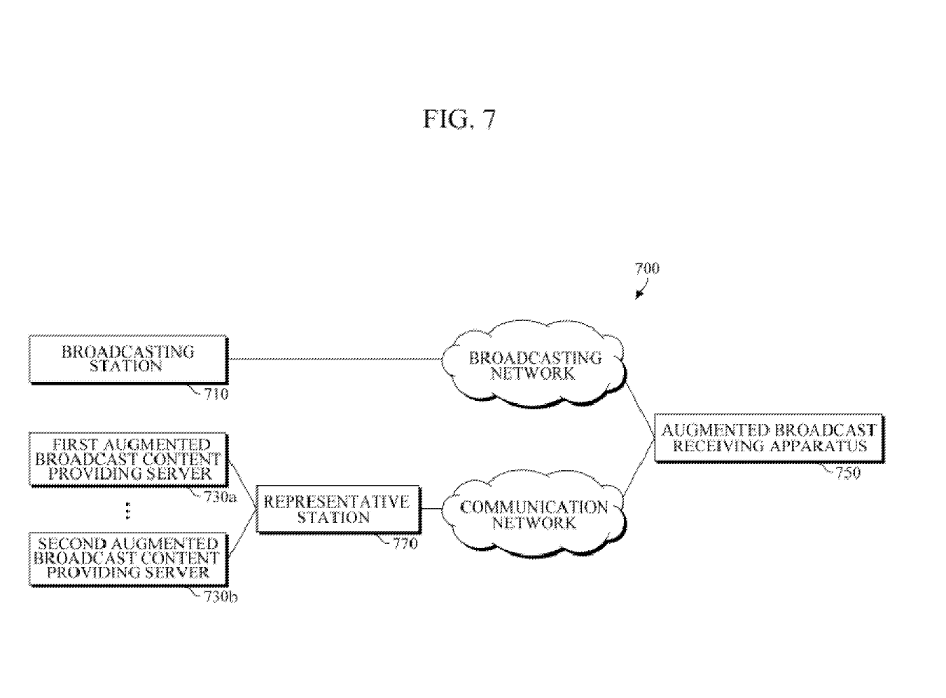

FIG. 7 is a diagram illustrating a configuration of an augmented broadcast content providing system according to another embodiment of the present invention.

Referring to FIG. 7, an augmented broadcast content providing system 700 according to another embodiment of the present invention may include a broadcasting station 710, augmented broadcast content providing servers 730a and 730b, an augmented broadcast receiving apparatus 750, and a representative server 770.

In this case, since the broadcasting station 710, the augmented broadcast content providing servers 730a and 730b, and the augmented broadcast receiving apparatus 750 are the same as those in FIG. 1, a detailed description thereof will be omitted.

The representative server 770 may receive an augmented broadcast content request signal from the augmented broadcast receiving apparatus 750 and provide augmented broadcast content to the augmented broadcast receiving apparatus 750.

In this case, the representative server 770 may receive information of the augmented broadcast content providing server selected by a user and information for a content type together with the augmented broadcast content request signal from the augmented broadcast receiving apparatus 750, and provide the augmented broadcast content based on the information. The representative server 770 may store and manage the information for the augmented broadcast content providing server selected by the user and the information for the content type, independently from the augmented broadcast receiving apparatus 750.

The representative server 770 may directly store and manage the augmented broadcast content provided by the respective augmented broadcast content providing servers 730a and 730b or may store link information for the respective augmented broadcast content providing servers 730a and 730b. When the representative server 770 stores the link information for the respective augmented broadcast content providing servers 730a and 730b, if the augmented broadcast content request signal is received from the augmented broadcast receiving apparatus 750, the representative server 770 may access the augmented broadcast content providing server selected by the user, receive the augmented broadcast content, and provide the augmented broadcast content to the augmented broadcast receiving apparatus 750.

Meanwhile, when there are a plurality of users using the augmented broadcast receiving apparatus 750, the augmented broadcast receiving apparatus 750 identifies the user currently using the augmented broadcast receiving apparatus 750 using a user ID and a password and requests the representative server 770 to provide the augmented broadcast content for the identified user. The representative server 770 having received the augmented broadcast content request signal accesses the augmented broadcast content providing server selected by the identified user using the user ID and the password of the identified user, receives the augmented broadcast content corresponding to the content type selected by the user, and transmit the augmented broadcast content to the augmented broadcast receiving apparatus 750.

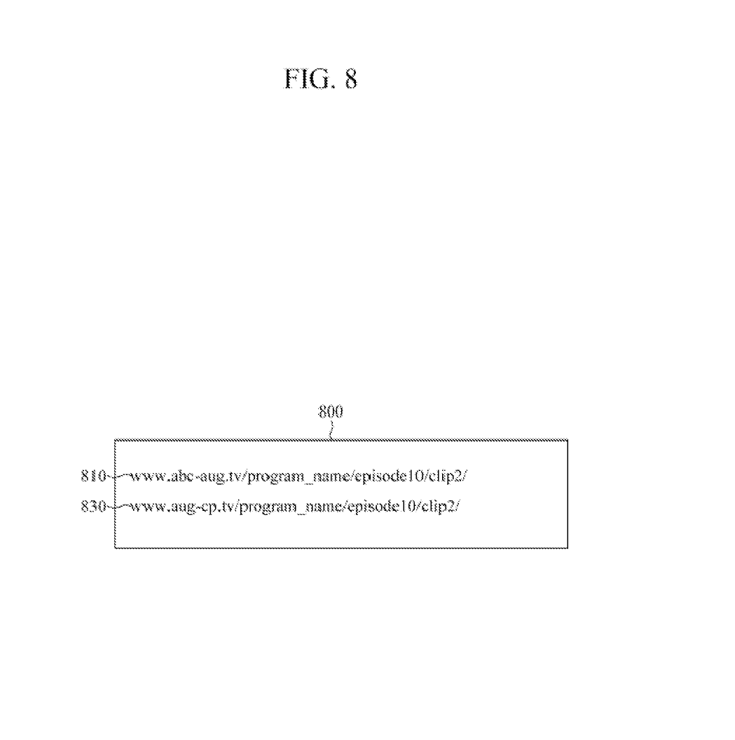

FIG. 8 is a diagram illustrating an example of augmented object information contained in metadata for the augmented broadcast content providing system 700 in FIG. 7.

FIG. 8 illustrates an example in which the broadcasting station 710 provides a broadcast program as well as an augmented broadcast content for the broadcast program. Augmented object information 800 may include URL information 810 for access to a server of the broadcasting station, and URL information 830 for access to the representative server 770, which provides the augmented broadcast content associated with the broadcast program.

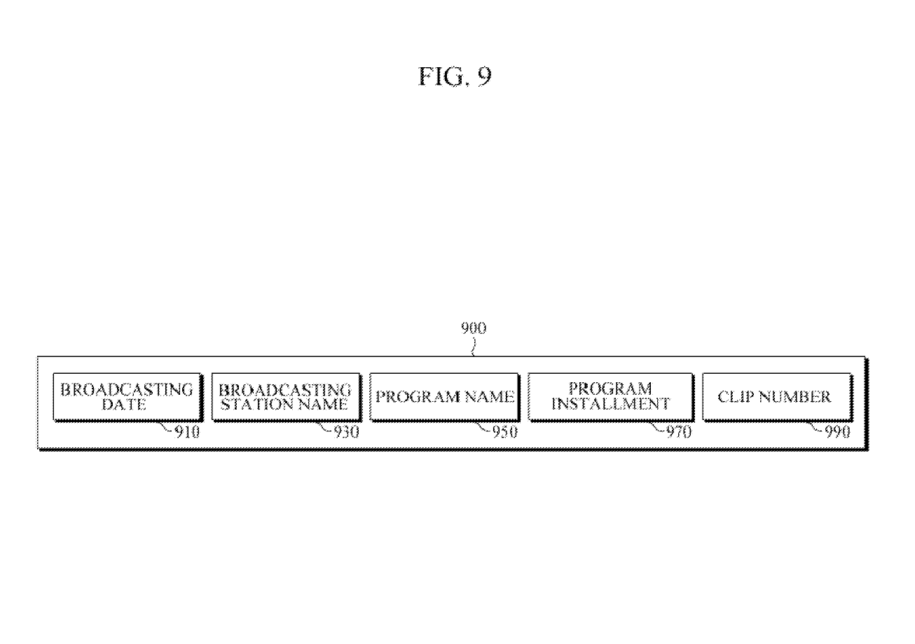

FIG. 9 is a diagram illustrating an example of elements of the augmented object information in FIG. 8.

Referring to FIG. 9, the elements of the augmented object information may include, for example, broadcasting date 910 for the broadcast program, a name 930 of a broadcasting station that broadcasts the broadcast program, a broadcast program name 950, a broadcast program installment 970, and a clip number 990 of the broadcast program. Here, when the augmented broadcast content is provided one or more times in the broadcast program, the clip number 990 is counted once for the individual augmented broadcast content.

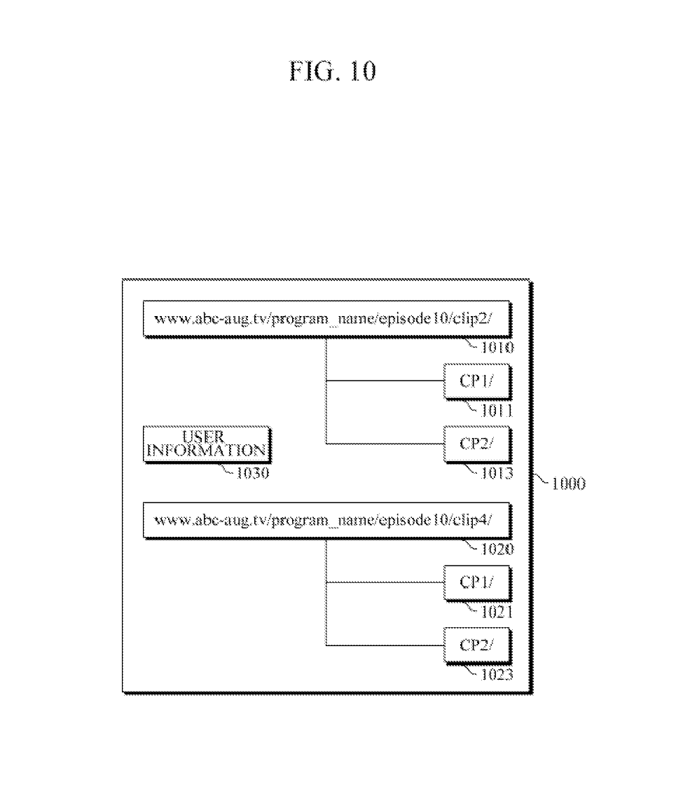

FIG. 10 is a diagram illustrating an example of a directory structure of the representative server 770 of FIG. 7 when the representative server 770 directly holds the augmented broadcast content, which is provided by each augmented broadcast content providing server.

Referring to FIG. 10, the representative server 770 stores information 1030 on each user. The information 1030 on each user may include information for the augmented broadcast content providing server or the content type selected by each user according to a broadcast program, an episode, or a clip number.

The representative server 770 includes subdirectories 1011, 1013, 1021, 1023 according to the augmented broadcast content providing server and the content type in the URL information pieces 1010 and 1020, which represent the elements of the augmented object information in FIG. 9.

The representative server 770 provides the augmented broadcast content of the directory to the augmented broadcast receiving apparatus 750 according to the information 1030 on each user.

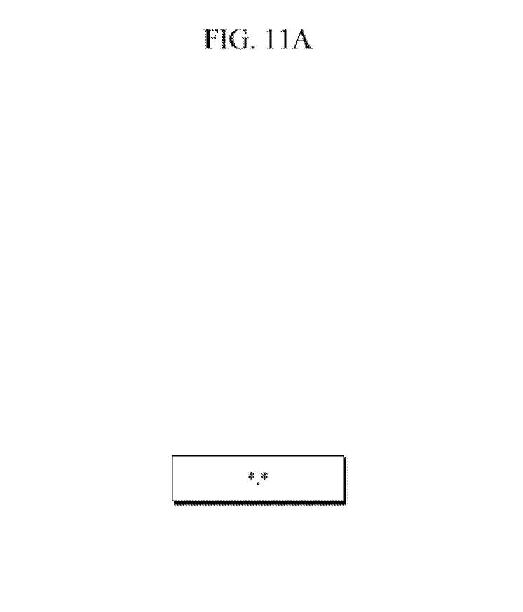

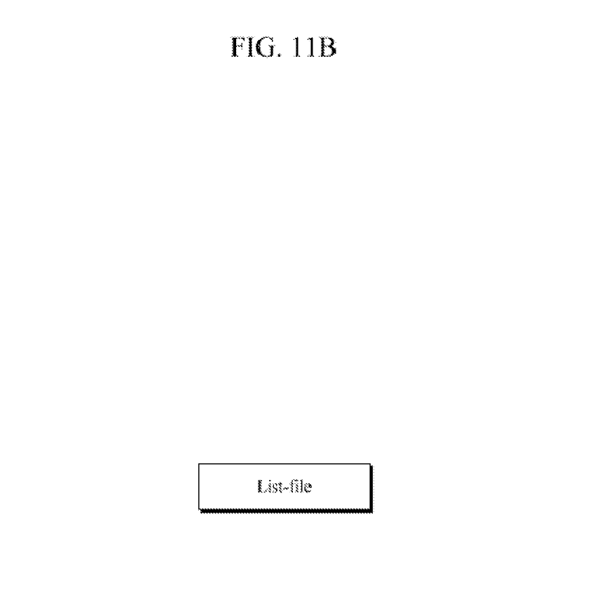

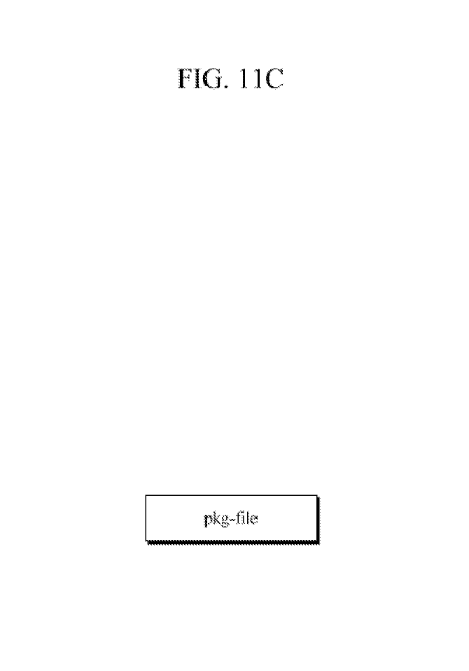

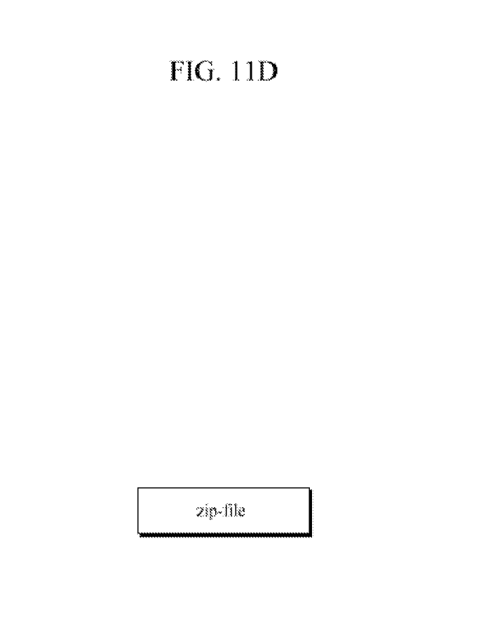

FIGS. 11a to 11d are diagrams illustrating examples of a structure of an augmented broadcast content file in the directory of the representative server 770 according to an embodiment of the present invention.

When the augmented broadcast content simply appears in the form of one file, the file only needs to be received by specifying a name of the file whereas when the augmented broadcast content consists of a plurality of files in the form of a package, the plurality of files must be able to be received.

FIG. 11a illustrates a structure of a file for providing all content in a directory, FIG. 11b illustrates a structure of a file when a list of related files is stored in list-file that is a representative file in a directory, and files specified by list-file are provided, FIG. 11c illustrates a structure of a file when related files are tied in the form of pkg-file as one file, and FIG. 11d illustrates a structure of a file when related files are tied in the form of zip-file as one file.

Here, pkg-file may have a different format according to individual augmented broadcast content.

Meanwhile, information on the file structures of FIGS. 11a to 11d may be included in the metadata, and may be internally set by receiving the augmented broadcast content.

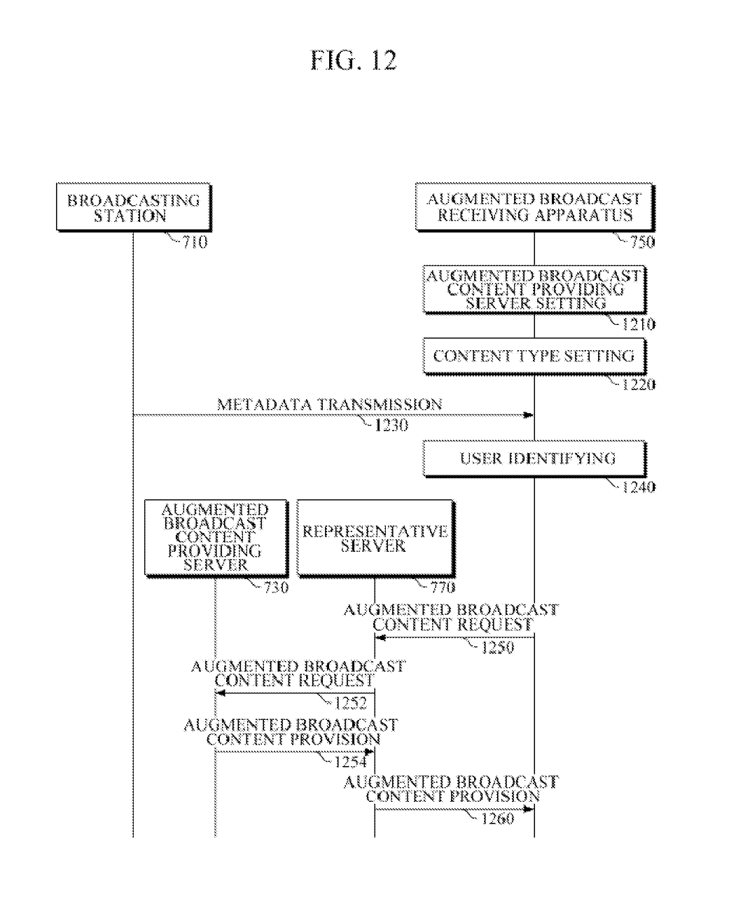

FIG. 12 is flowchart of a method of providing augmented broadcast content according to another embodiment of the present invention.

Referring to FIG. 12, in the method of receiving augmented broadcast content according to another embodiment of the present invention, one of a plurality of augmented broadcast content providing servers providing augmented broadcast content associated with a broadcast program is selected according to a selection of a user (1210). When the selected augmented broadcast content providing server provides a plurality of content types having a different attribute, one of the plurality of content types is then selected according to a selection of the user (1220).

The broadcast program and the metadata for augmented broadcast implementation for the broadcast program transmitted from the broadcasting station 710 over a broadcasting network are then received (1230).

When a plurality of users use the augmented broadcast receiving apparatus 750, a user currently using the augmented broadcast receiving apparatus 750 is then identified using a user ID stored in advance (1240).

The augmented broadcast receiving apparatus 750 then requests the representative server 770 to provide the augmented broadcast content (1250), the representative server 770 requests the augmented broadcast content providing server 730 selected by the identified user to provide the augmented broadcast content (1252), the augmented broadcast content providing server 730 having received a content request signal provides the augmented broadcast content to the representative server 770 (1254), and the representative server 770 provides the received augmented broadcast content to the augmented broadcast receiving apparatus 750.

The case in which the representative server 770 stores only the link information for each augmented broadcast content providing server that provides the augmented broadcast content associated with the broadcast program has been described with reference to FIG. 12. However, operations 1252 and 1254 may be omitted when the representative server 770 has stored the augmented broadcast content, which is provided by each augmented broadcast content providing server. In other words, when the augmented broadcast receiving apparatus 750 requests the representative server 770 to provide the augmented broadcast content (1250), the representative server 770 provides the augmented broadcast content stored in the subdirectory for the augmented broadcast content providing server and the content type selected by the identified user to the augmented broadcast receiving apparatus 750 (1260).

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of receiving augmented broadcast content, the method comprising:
receiving a broadcast program and metadata for augmented broadcast implementation for the broadcast program that are transmitted over a broadcasting network;
requesting an augmented broadcast content providing server providing augmented broadcast content associated with the broadcast program to provide the augmented broadcast content associated with the broadcast program with reference to the received metadata; and
receiving the augmented broadcast content provided by the augmented broadcast content providing server according to the request.

2. The method according to claim 1, further comprising:
selecting one of a plurality of augmented broadcast content providing servers that provide the augmented broadcast content associated with the broadcast program, according to a selection of a user.

3. The method according to claim 2, wherein the requesting of the augmented broadcast content includes requesting the selected augmented broadcast content providing server to provide the augmented broadcast content associated with the broadcast program.

4. The method according to claim 2, wherein the requesting of the augmented broadcast content includes requesting an augmented broadcast content providing server selected by default to provide the augmented broadcast content associated with the broadcast program, when there is no selection of the user.

5. The method according to claim 2, further comprising:
when the selected augmented broadcast content providing server provides a plurality of content types having a different attribute, selecting one of the plurality of content types according to a selection of the user.

6. The method according to claim 2, further comprising:
when there are a plurality of users using an augmented broadcast receiving apparatus, identifying the user currently using the augmented broadcast receiving apparatus based on a user ID stored in advance.

7. The method according to claim 6, wherein the requesting of the augmented broadcast content includes requesting the augmented broadcast content providing server selected by the identified user to provide the augmented broadcast content associated with the broadcast program.

8. The method according to claim 1, wherein the requesting of the augmented broadcast content includes requesting a representative server to provide the augmented broadcast content associated with the broadcast program with reference to the received metadata, and
the representative server stores information for a plurality of augmented broadcast content providing servers that provide the augmented broadcast content associated with the broadcast program or information for the augmented broadcast content provided by each augmented broadcast content providing server.

9. The method according to claim 1, wherein the metadata includes at least one of augmented object information that is information for an object of the augmented broadcast content to be applied to the broadcast program, augmented area information that is information for a spatial arrangement of the augmented broadcast content object on a screen in which the broadcast program is output, and augmented time information that is information for a temporal arrangement of the augmented broadcast content object in the broadcast program.

10. The method according to claim 9, wherein the augmented object information includes at least one of broadcasting date information of the broadcast program, a name of a broadcasting station that broadcasts the broadcast program, name information of the broadcast program, installment information of the broadcast program, and clip number information of the broadcast program.

11. An apparatus for receiving augmented broadcast, the apparatus comprising:
is a broadcast/metadata reception unit configured to receive a broadcast program and metadata for augmented broadcast that are transmitted over a broadcasting network;
a content request unit configured to request an augmented broadcast content providing server providing augmented broadcast content associated with the broadcast program to provide the augmented broadcast content associated with the broadcast program with reference to the received metadata; and
a content reception unit configured to receive the augmented broadcast content provided by the augmented broadcast content providing server according to the request.

12. The apparatus according to claim 11, further comprising:
a server selection unit configured to select one of at least one augmented broadcast content providing server that provides the augmented broadcast content associated with the broadcast program, according to a selection of a user.

13. The apparatus according to claim 12, further comprising:
a content type selection unit configured to select one of a plurality of content types having a different attribute according to a selection of a user when the selected augmented broadcast content providing server provides the plurality of content types.

14. The apparatus according to claim 11, further comprising:
a user identifying unit configured to store a user ID and identify a user currently using the augmented broadcast receiving apparatus based on the stored user ID.

15. The apparatus according to claim 11, wherein the metadata includes at least one of augmented broadcast content object information that is information for an object of the augmented broadcast content to be applied to the broadcast program, augmented broadcast content area information that is information for a spatial arrangement of the augmented broadcast content object on a screen in which the broadcast program is output, and augmented broadcast content time information that is information for a temporal arrangement of the augmented broadcast content object in the broadcast program.

16. The apparatus according to claim 15, wherein the augmented object information includes at least one of broadcasting date information of the broadcast program, a name of a broadcasting station that broadcasts the broadcast program, name information of the broadcast program, installment information of the broadcast program, and clip number information of the broadcast program.

17. A system for providing augmented broadcast content, the system comprising:
at least one augmented broadcast content providing server configured to store augmented broadcast content associated with a broadcast program; and
an augmented broadcast receiving apparatus configured to receive the broadcast program and metadata for augmented broadcast that are transmitted over a broadcasting network, request the augmented broadcast content providing server to provide the augmented broadcast content associated with the broadcast program with reference to the received metadata, and receive the augmented broadcast content associated with the broadcast program.
